(19) United States
(12) Patent Application Publication
(10) Pub. No.: US 2023/0128498 A1
(43) Pub. Date: Apr. 27, 2023

(54) AUTOMATED PIZZA CUTTER

(71) Applicant: Edge Exponential LLC, Gahanna, OH (US)

(72) Inventor: Christopher Tyler, Gahanna, OH (US)

(21) Appl. No.: 17/972,206

(22) Filed: Oct. 24, 2022

Related U.S. Application Data
(60) Provisional application No. 63/271,408, filed on Oct. 25, 2021.

(51) Int. Cl. B26D 3/24; B26D 1/25; B26D 5/08

(52) U.S. Cl. CPC B26D 3/245; B26D 1/25; B26D 5/08; B26D 7/088

(57) ABSTRACT

An automated pizza cutter with a blade and a pizza resting on a working surface. Horizontal, vertical and/or rotational relative movement between the blade and the pizza is effected by different embodiments. The working surface can be moved rotationally relative to the blade, and the blade may be moved horizontally and/or vertically relative to the working surface. In one embodiment, a rotatably driven table supports a pizza while a blade disposed above the table is configured to move vertically and horizontally. A programmable user interface allows operation of the cutter. After the cutting process is completed, a blade cleaner wipes the blade of debris, which eliminates cross contamination between different types of pizzas.

### BACKGROUND OF THE INVENTION

The invention relates generally to devices for processing food, and more particularly to machines used to cut food products into smaller pieces.

Pizza is well known to be a generally planar food product made by placing toppings, such as sauce, cheese and pepperoni, on a circular or rectangular crust. A circular pizza crust is a disk with thickness ranging from a fraction of an inch to about an inch after baking. Pizzas are typically baked after placing toppings on raw dough, thereby forming a generally planar, completed food product. Most pizzas are cut into smaller pieces in order to be consumed. However, cutting pizza is a time-consuming, and potentially dangerous, activity.

Baked pizzas are conventionally cut into pieces using a knife. Pizza-cutting knives for home use commonly have a handle with a round blade rotatably mounted on an axle at the end of the handle. Such knives can be rolled to cut pizza using the sharp edge. Elongated knives used in pizza shops, where time is of the essence, have handles at both ends. However, such elongated knives require significant strength to cut the pizza, and these knives are also more dangerous due to their weight and the fact that they require strength, dexterity and coordination to safely and efficiently cut pizzas.

When a large quantity of orders is received in most retail pizza-making operations, the step of cutting pizzas can cause a “bottleneck” that reduces product throughput due to the skill and speed required to safely and effectively cut the pizza. Furthermore, danger is increased when an operator wipes the elongated, heavy blade after each pizza to avoid contaminating a pizza with the ingredients of the preceding pizza(s).

There is a need for safer, more efficient pizza cutting machines and methods.

### SUMMARY OF THE INVENTION

Disclosed herein is an apparatus for cutting food products, the apparatus comprising a frame having a table with a working surface and a blade disposed adjacent the working surface. The apparatus further comprises a drive system mounted to the frame. The drive system includes a rotary prime mover that is configured for effecting rotational relative motion between the table and the blade, and a cutting linear prime mover that is configured for effecting proximal relative motion between the blade and the table. In some embodiments, the drive system also includes an aligning linear prime mover configured for effecting horizontal relative motion between the blade and the table. Some embodiments include a flexible member mounted across a slot formed in a block, wherein the block is configured to move parallel to the length of the blade.

In some embodiments, the table is rotatably mounted to the frame and the rotary prime mover is drivingly linked to the table for rotating the table relative to the frame. In other embodiments, the blade is rotatably mounted to the frame and the rotary prime mover is drivingly linked to the blade for rotating the blade relative to the table.

In some embodiments, the cutting linear prime mover is drivingly linked to the blade for displacing the blade vertically relative to the table. In other embodiments, the cutting linear prime mover is drivingly linked to the table for displacing the table vertically relative to the blade.

In some embodiments, the aligning linear prime mover is drivingly linked to the blade for displacing the blade horizontally relative to the table. In other embodiments, the aligning linear prime mover is drivingly linked to the table for displacing the table horizontally relative to the blade.

Disclosed herein is an automated pizza cutter that is used to efficiently and safely cut various types and sizes of crusts and pizzas using different cutting patterns. The disclosed automated pizza cutter alleviates the bottleneck in the retail environment by increasing pizza throughput. The disclosed method of cutting can accommodate any size or cutting pattern from the positional blade system. An integrated and optional blade cleaner cleans the blade after each pizza to increase workplace safety and reduce cross contamination.

The apparatus improves the customer experience by ensuring that each pizza is cut consistently by the apparatus, and is cut through entirely and evenly every time. Additionally, the cut pattern is executed exactly to specification every time. A cut pattern executed to specification results in a pizza with every slice having the desired size and shape.

### BRIEF DESCRIPTION OF THE DRAWINGS

FIG. 1 is a view in perspective illustrating an embodiment of the invention.

FIG. 2 is a view in perspective illustrating a belt drive system that drives the blade left to right and front to back in the embodiment of FIG. 1.

FIG. 3 is a view in perspective illustrating a rotation system that causes the blade to rotate in the embodiment of FIG. 1.

FIG. 4 is a view in perspective illustrating pneumatic cylinders that control the blade cutting into the pizza in the embodiment of FIG. 1.

FIG. 5 is a top view illustrating a control system in the embodiment of FIG. 1.

FIG. 6 is a front view illustrating a user interface which allows the operator to select a customizable cutting option in the embodiment of FIG. 1.

FIG. 7 is a view in perspective illustrating a blade cleaning device in the embodiment of FIG. 1.

FIG. 8 is a view in perspective illustrating an alternative embodiment of the present invention.

FIG. 9 is a top view in perspective illustrating a structure for driving the linear actuators in the embodiment of FIG. 8.

FIG. 10 is a view in perspective illustrating the linear actuators of the embodiment of FIG. 9.

FIG. 11 is a rear view illustrating the rear of the embodiment of FIG. 8 with a protective panel removed.

FIG. 12 is a view in perspective illustrating the inside of the cabinet of the embodiment of FIG. 8 showing the table drive motor.

FIG. 13 is a view in perspective illustrating an alternative blade-cleaning apparatus.

FIG. 14 is an end view illustrating the blade-cleaning apparatus shown in FIG. 13.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

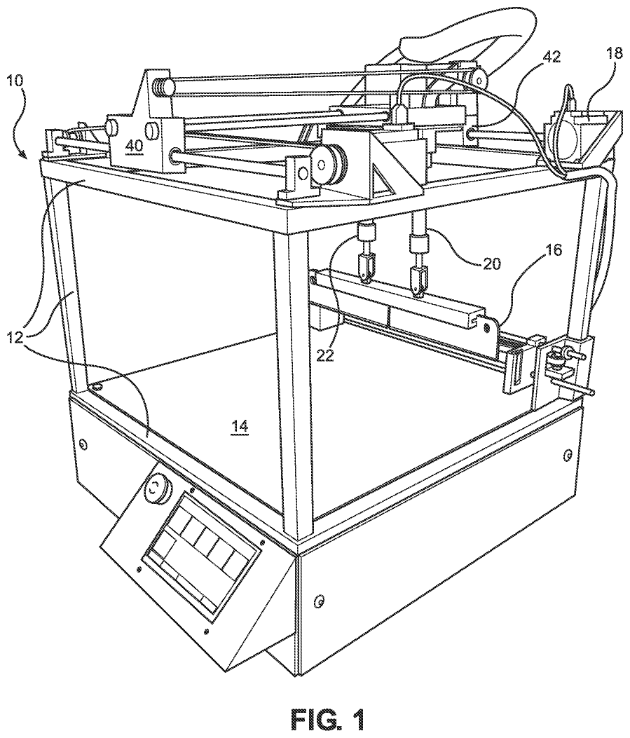

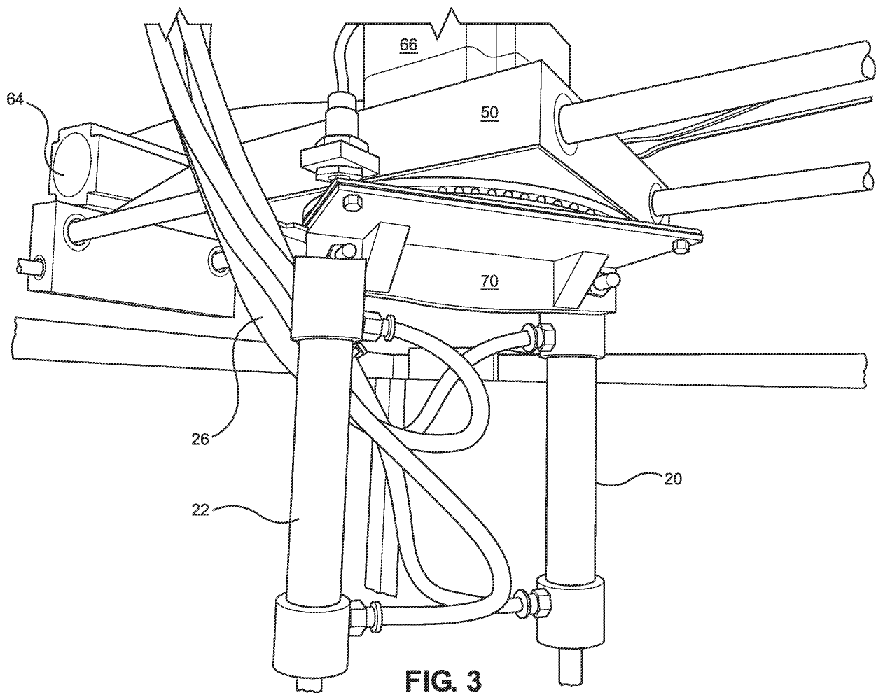

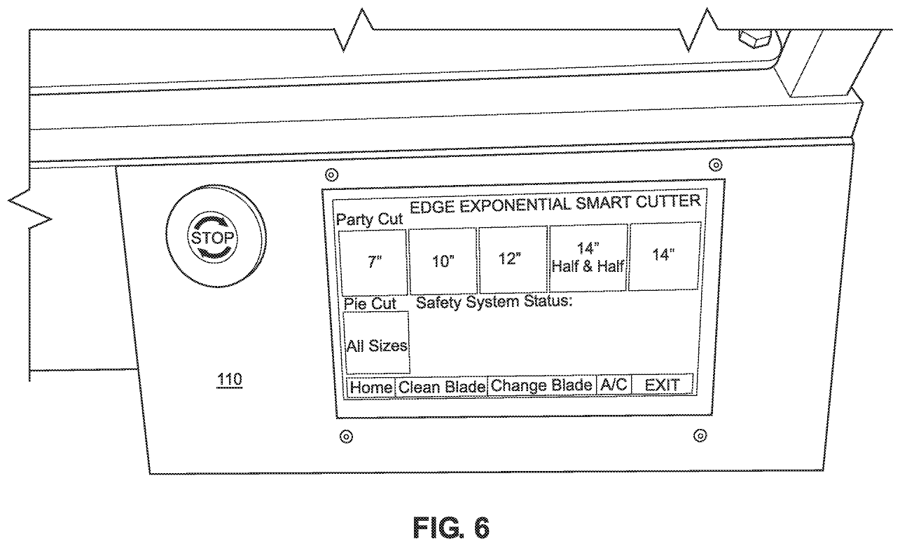

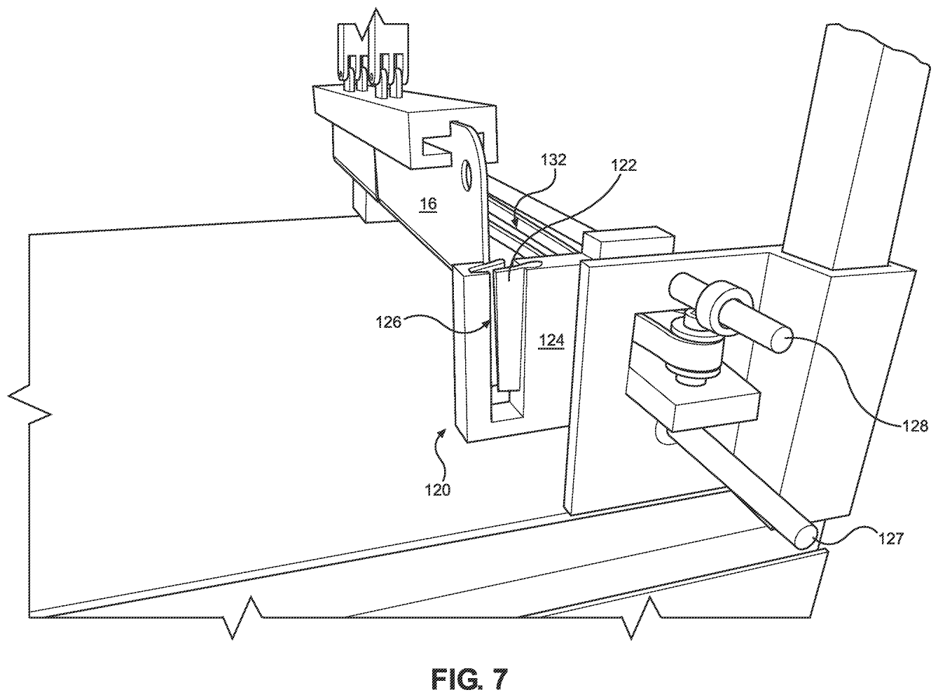

FIGS. 1-7 show an automated pizza cutter 10 that allows anyone, such as individuals, retail pizza stores or any other pizza-making operation, to cut any size pizza efficiently and safely. The automated pizza cutter 10 can form any cut pattern made up of straight lines, including, without limitation, radial cuts in a circular pizza that form triangular pieces (with one edge of the circular pizza crust forming a rounded side of each triangular piece of pizza), and cuts along the chords of a circular pizza that result in squares and triangular pieces of pizza.

The cutter 10 has a frame 12 that may be made of square steel tubing welded at junctures and forming a foundation to which other components are mounted. Metal sheets may be welded or otherwise fastened to the frame 12 to become a part of the frame 12. A table 14 is a substantially planar structure with an upper surface larger than both the blade and any pizza that will be cut in the cutter 10. The table 14 extends across frame members to form a substantially horizontal (in an operable position) working surface upon which a cooked pizza may be disposed and cut. The table may be metal, wood, plastic or any suitable material. In one embodiment, the table is a square that is about 24 inches on each side, and is formed from a thick sheet of stainless steel.

A blade 16 is disposed above the table 14 and is drivingly linked to a drive system 18. The blade 16 may be a rectangular, flat strip with straight edges forming a substantially planar high carbon steel sheet with a sharp, downwardly-facing edge 17 and lateral and top edges that may not be sharpened. The sharp edge 17 of the blade 16 is preferably sufficiently sharp to cut pizzas under the circumstances described herein, and is parallel to the upper surface of the table 14. The drive system 18 may include one or more linear actuators, such as electric, pneumatic or hydraulic rams, which could also be other linear actuators such as screws. The pneumatic rams 20 and 22 shown are vertically oriented with their lower, driven ends attached to the upper edge of the blade 16 and their upper, stationary ends mounted to a rotary driver 70 that is part of the drive system 18.

The blade 16 can be moved rotationally, vertically and/or horizontally relative to a pizza using the drive system 18. This allows precise, clean cuts with vertical displacement of the blade, after rotational and horizontal displacement has stopped, using the integrated pneumatic rams 20 and 22. No pizza is shown in the drawings, but a pizza may be placed on the working surface of the table 14 with the pizza's plane parallel to the table 14 and its outer edges within the boundaries of the table 14.

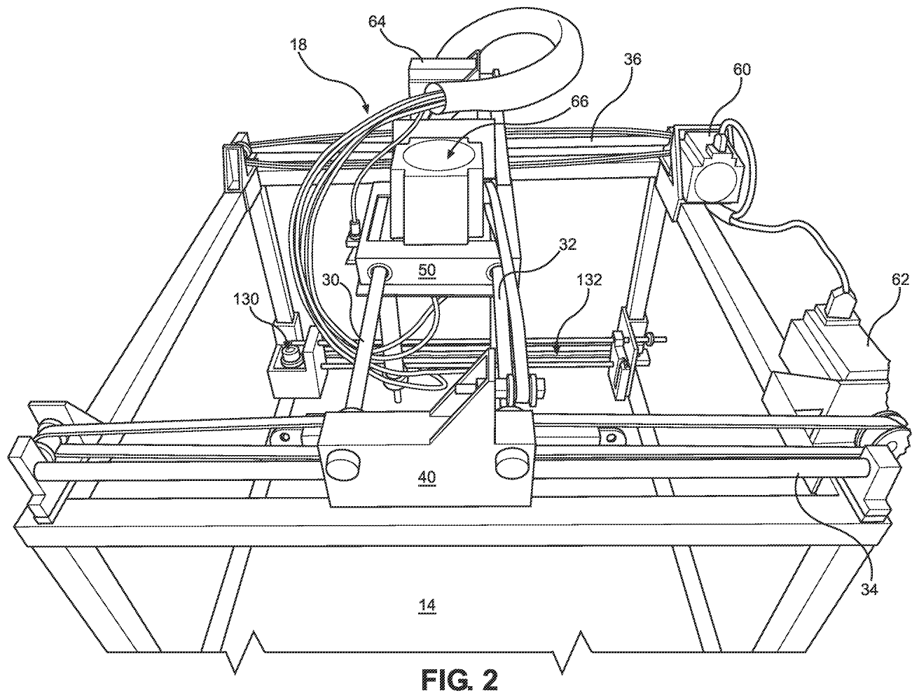

The drive system 18 is shown in more detail in FIG. 2, including the rods 30 and 32 and the rods 34 and 36, which are disposed perpendicularly to the rods 30 and 32. The rods 30 and 32 extend slidably, such as through smooth bearings, through a moveable cart 50 to which the rams 20 and 22 are movably mounted through the driver 70. The rods 30 and 32 thus guide the cart 50 along one longitudinal axis of movement relative to the table 14: parallel to the rods 30 and 32. The rods 30 and 32 are rigidly mounted at their ends in the brackets 40 and 42, through which the rods 34 and 36, respectively, extend slidably, such as through smooth bearings. The brackets 40 and 42 may thus glide smoothly along the rods 34 and 36 in a direction perpendicular to the direction the cart 50 slides along the rods 30 and 32.

The cart 50 may be driven along the rods 30-36 in a preferably horizontal plane that is parallel to the plane of the table 14. The cart 50 may be driven by one or more prime movers, such as the stepper or servo motors 60 and 62, and the stepper or servo motor 64. The motors 60-64 may drive cogged belts that are attached to the brackets 40 and 42 and the cart 50 in a conventional manner, causing the drive system 18 to move as further described below.

The rotary driver 70, to which the rams 20 and 22 are rigidly mounted, may be mounted beneath the cart 50. The prime mover 66 may rotate the rotary driver 70 in rotational movement relative to the cart 50. This moves the rams 20 and 22, and there is sufficient compressed gas line 26 to accommodate rotational movement of the driver 70 relative to the cart 50 in both directions from about 90 to 270 degrees from a home position. The drive system 18 may thus drive the blade 16 rotationally, vertically (upwardly, downwardly), horizontally (front-to-back and/or laterally), and any combination relative to the table 14. There are components in the drive system 18 that accommodate a vertical cutting movement of the blade 16, along with a substantially horizontal alignment movement of the blade 16, which is horizontal movement substantially parallel to the plane of the working surface of the table 14. These movements may be separated into discrete movements, or they may be simultaneous.

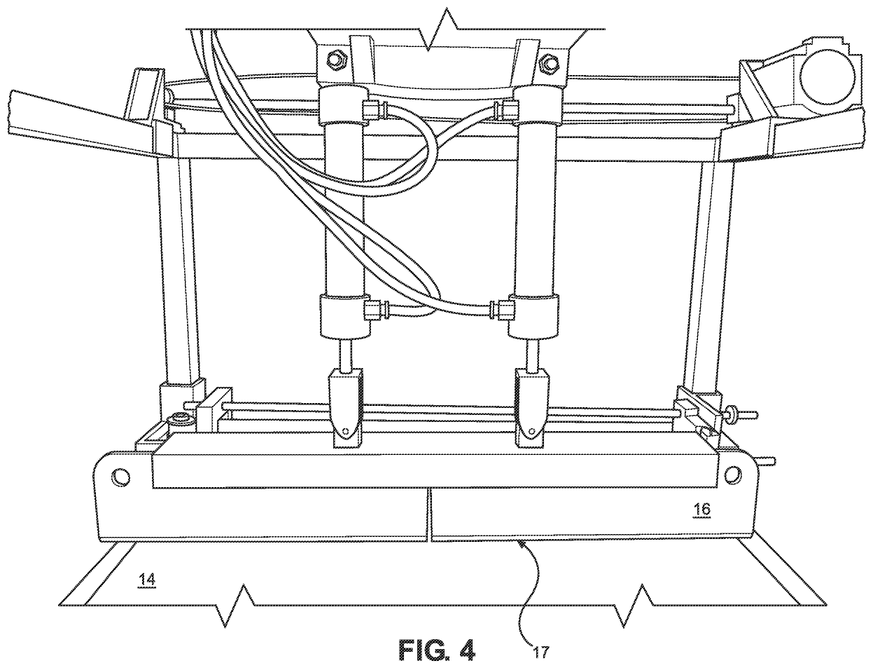

As shown in FIG. 4, the blade 16 may be disposed above the table 14 by at least about the thickness of the pizza with the blade's lower edge 17 substantially parallel to the upper surface of the table 14. When a pizza is placed on the table 14, the blade 16 is driven downwardly, while maintaining its downwardly-facing edge 17 parallel to the table, into the pizza until the blade contacts the upper surface of the table or comes just above that position, thereby forming a first cut in the pizza. Alternatively, a pizza may be placed on the table 14 on a peel, which is a large spatula, and the rams 20 and 22 may be driven a distance that cuts the pizza and takes into consideration the thickness of the peel. The blade may then be driven upwardly, moved horizontally or rotationally, and then driven down to make another cut.

The prime movers 60-66 of the drive system 18, which may be connected to a computer 100 beneath the table 14 or elsewhere in the frame 12, may be actuated to drive the cart 50, and therefore the blade 16, horizontally or rotationally relative to the pizza, so the blade 16 can form a cut a spaced distance from the first cut. Once the blade is in the desired position relative to the previous cut, the rams 20 and 22 may be driven to move the blade 16 down and up again, to form another cut in the pizza at a location distal from the first cut. For example, if the first cut is along the diameter of a circular pizza, the second cut may be along another diameter of the same pizza after rotating the blade a predetermined amount from the first cut, such as ten to twenty degrees. If this process is repeated, these cuts form triangular pieces of the same size. Alternatively, the first cut may be a chord near one edge, and subsequent cuts may be parallel to the first cut but along another chord, one of which may be through the center of the circular pizza. After this first set of parallel cuts is formed, the blade may be rotated 90 degrees relative to the pizza and additional chord cuts may be made through the pizza that are perpendicular to the first cuts. Such a pattern of cutting may form rectangular pieces with four triangular pieces.

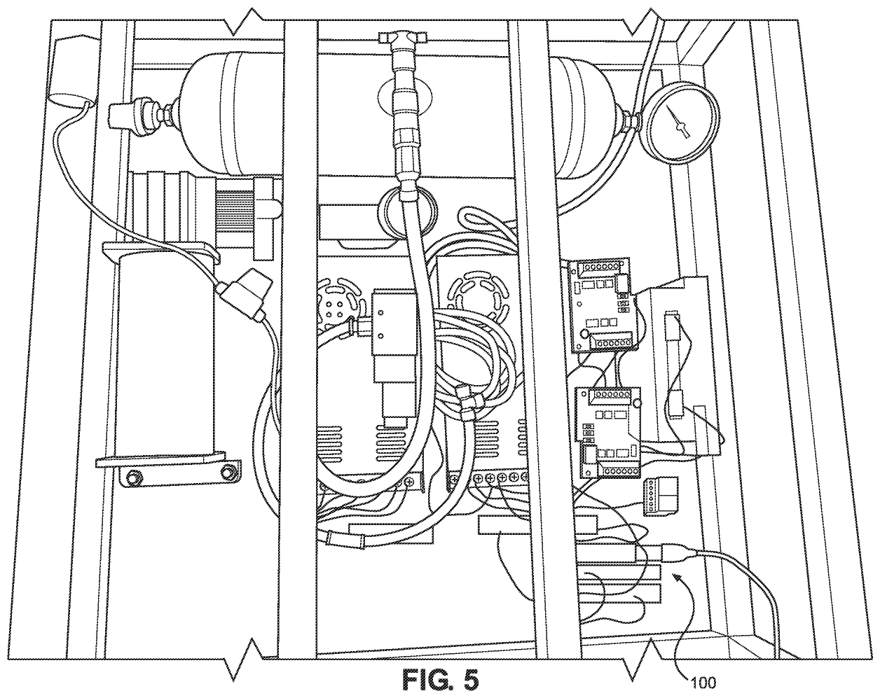

The drive system 18 may include an air compressor, air tank, pressure regulator and solenoid valves. In addition, the motor drivers are shown. The cutter 10 may be powered by a compressor and/or a bottle of pressurized gas mounted beneath the table 14, as shown in FIG. 5. The prime movers 60-66 may be electrically powered and controlled by the computer 100 that is connected to the prime movers 60-66. A touch screen control unit 110 may be mounted on the front surface of the cutter 10, and may be connected to the computer 100. Thus, an operator may press a button on the touch screen thereof that corresponds to the diameter of a circular pizza, thereby programming the computer 100 with information corresponding to the size of the pizza, and the computer 100 then actuates the drive system 18 of the cutter 10 to operate with one or more of the cutting steps described above to complete the pizza cutting process that was instructed by the operator.

An optional blade cleaner 120 that can work with the embodiment of FIGS. 1-7, or any other embodiment, includes a flexible squeegee member 122 mounted across a slot 126 formed in a block 124. The squeegee 122 is a substantially planar piece of flexible material, which may be rubber, polyurethane or other equivalent materials, which flexes when the blade 16 contacts the squeegee 122. This permits the squeegee 122 to wipe pizza sauce and other ingredients from the blade 16 in the manner that a window squeegee wipes water and soap from a window. The block 124 is a rigid body that is slidably mounted on two rods 127 and 128 to move parallel to the length of the blade 16 as driven by a prime mover, such as the servo motor 130 that drives a cogged belt 132 mounted to the block 124. This allows the operator to avoid touching a sharp cutting object (the blade 16) while cleaning the sharp object between cutting pizzas, thereby maintaining workplace safety while avoiding contamination from pizza to pizza. The design of the blade cleaner 120 allows an effective, one-swipe operation to adequately clean the blade 16 to avoid cross contamination.

A pizza can be loaded in the cutter 10 from the front or either of the two sides.

The drive system 18 moves the blade 16 horizontally with precision laterally (from left to right), longitudinally (from front to back), and any combination of the two, to align the blade with the pizza on the working surface. The rotating system rotates the blade 16 in either direction about a vertical axis. The drive system 18 displaces the blade 16 vertically toward (more proximal) and away (less proximal) from the pizza to cut the pizza as described above. The blade cleaning device 120 may make one pass or more with the rubber squeegee 122 to remove debris from the blade's 16 cutting surface effectively and safely.

The efficiency of the cutter 10 alleviates bottlenecks in the pizza operation because the cutter 10 can cut pizza very rapidly and very accurately with extreme safety. Combined with the customizable user interface and blade cleaner, the automated pizza cutter 10 is safe and easy to use.

The cutter 10 has rotational and lateral control to allow for precise cutting of pizzas. Preferably there are size and crust selection options, along with cut pattern selection options, in the programmed user interface. A pneumatic air system using the pneumatic rams 20 and 22 is one example of a linear actuator that controls the vertical movement of the blade 16 that cuts the pizza, including controlling the force, speed and any other parameters of blade movement. Alternatively, any linear actuator could be substituted for the pneumatic air system, including a linear electric actuator, a stepper motor, hydraulic rams, screws, and any other suitable system. The integrated blade cleaner 120 meets health protocols surrounding cross contamination. The cutter 10 results in increased pizza throughput at a congested area of most pizza-making operations. A customizable user interface meets customer needs. In order to avoid sliding the pizza laterally while cutting, the blade is maintained parallel to the cutting surface while cutting. Furthermore, it is preferred that the blade is not moved horizontally during the vertical cutting stroke of the blade 16 toward and away from the table 14.

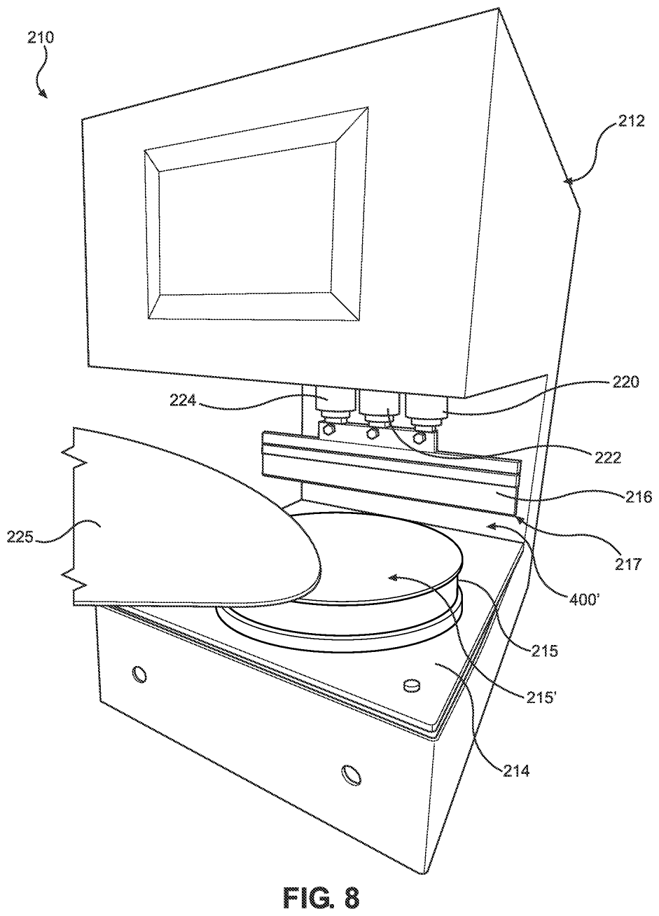

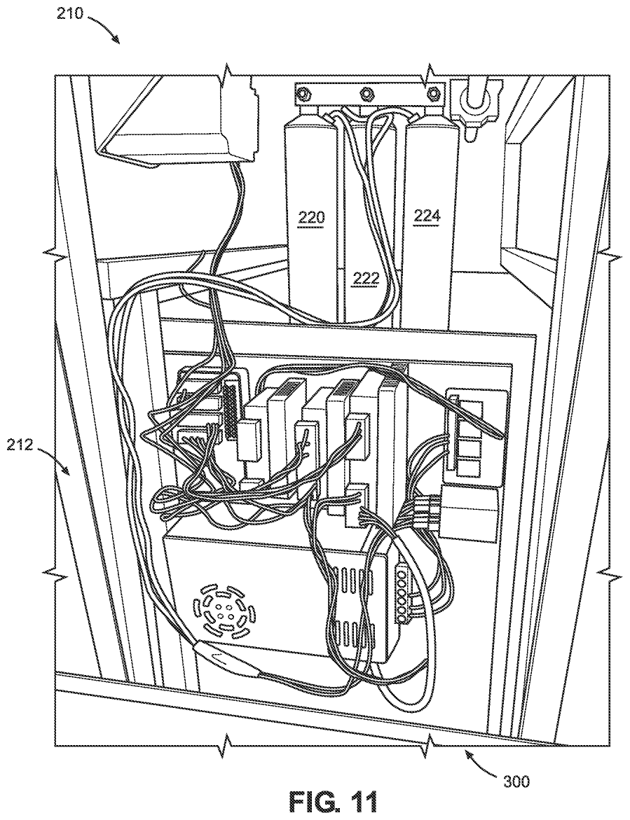

FIGS. 8-13 show an alternative embodiment automated cutter 210. The cutter 210 can form any cut pattern made up of straight lines and does so with an alternative drive system, among other differences, compared to the embodiment described and shown in relation to FIGS. 1-7. The cutter 210 has a frame 212 that may be made of square steel tubing welded at junctures combined with a sheet metal skin and forming a foundation to which other components are mounted. A platform 214 is a substantially planar surface larger than both the blade 216 and any pizza that will be cut in the cutter 210, and extends across frame members 212 to form a substantially horizontal (in the operable position shown in FIG. 8) surface.

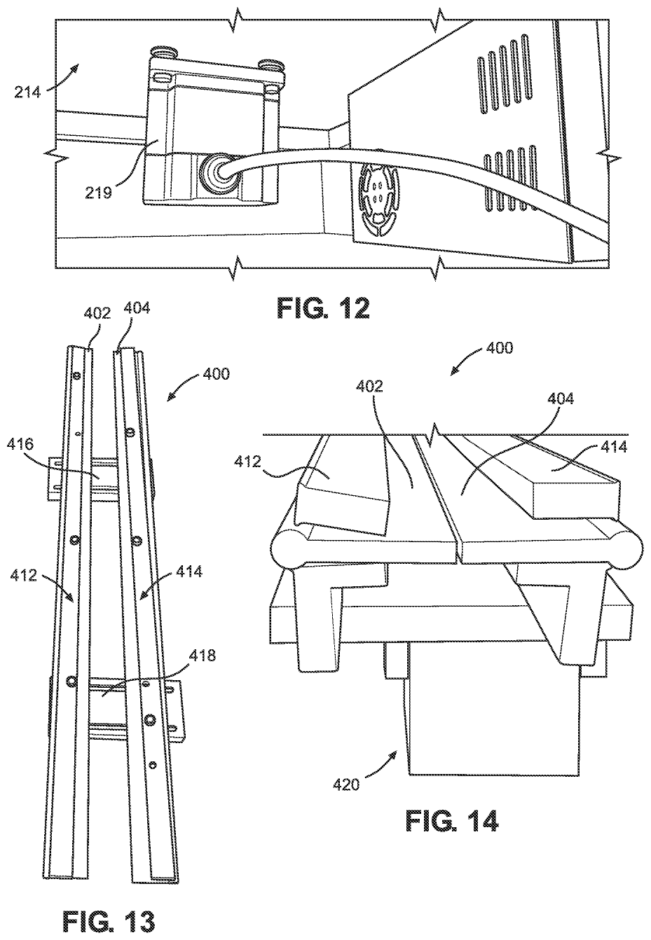

A rotatable table 215 is disposed above the platform 214 and has a horizontal working surface 215′ upon which a cooked pizza may be disposed and cut. The table 215 may be metal, wood, plastic or any suitable material. In one embodiment, the table 215 is a circular plastic disk that is about 18 inches in diameter. The table 215 is driven in rotation by a prime mover, such as a stepper motor or a servo motor. The table drive motor 219, which is illustrated in FIG. 12, is disposed in the housing of the cutter 210, preferably beneath the platform 214 and with a driveshaft that extends upwardly and drivingly links to the table 214. The table drive motor 219 is preferably connected to a computer 300 that all other drive mechanisms are connected to and controlled by. Thus, the table drive motor 219 drives the table 215 rotationally a predetermined amount (e.g., 90 degrees) and in a predetermined direction at a predetermined time that is according to programming of the computer 300.

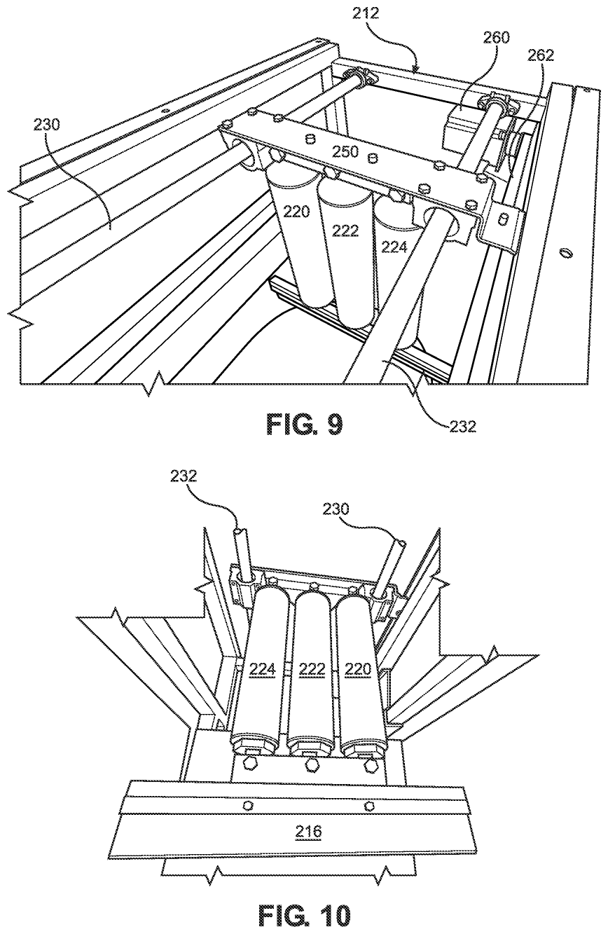

A blade 216 is disposed above the working surface 215′ of the table 215 and is drivingly linked to a drive system 218. The blade 216 may be substantially planar high carbon steel with a sharp, downwardly-facing edge 217 and lateral and top edges that may not be sharpened. The sharp edge 217 of the blade 216 is preferably sufficiently sharp to cut pizzas under the circumstances described herein. The drive system 218 may include one or more linear actuators, such as pneumatic or hydraulic rams, or screws. The linear actuators 220, 222 and 224 shown are vertically oriented with their lower, driven ends attached to the upper edge of the blade 216 and their upper, stationary ends mounted to the drive system 218 (see FIGS. 9 and 10).

The blade 216 can be displaced vertically relative to a pizza resting on the surface 215′ using the drive system 218. The linear actuators 220, 222 and 224 effect precise, clean cuts in the downward direction and then precise displacement of the blade 216 in the upward direction. No pizza is shown in the drawings, but a pizza may be placed on the surface 215′ with the pizza's plane parallel to the table 215 and its outer edges within the boundaries of the table 215.

In some embodiments, the blade may remain vertically stationary, and linear actuators similar to the actuators 220-224 are drivingly linked to the table to drive the table vertically. Such movement causes a cutting of the pizza resting on the table by relative proximal movement between the table and the blade where the blade is stationary relative to the frame and the table is displaced. This alternative illustrates the principle that there may be a reversal of the parts, which are described as being displaced relative to a stationary part, that may be moved and that may remain stationary. Of course, it is also contemplated that both parts may be moved, so long as there is relative movement between the parts. As another example, the table 215 rotates relative to the blade 216, whereas in the embodiment of FIGS. 1-7 the blade 16 rotates and the table 14 remains stationary. Although more complex and expensive, it is contemplated that both the blade and the table may be rotated.

The drive system 218 includes structures along which other components may slide horizontally. The drive system 218 is shown in more detail in FIG. 9-11, including the longitudinal rods 230 and 232 that are disposed generally in a front-to-back orientation on the cutter 210. The rods 230 and 232 are shown in FIG. 10, which is a view looking toward the back of the cutter 210 from the front of the cutter 210. The rods 230 and 232 attach rigidly, and alternatively rotatably, to the frame 212. This configuration rigidly disposes the rods 230 and 232 parallel to one another above the table 215 in a generally horizontal orientation that is maintained during use of the cutter 210.

The rods 230 and 232 extend slidably, such as through smooth bearings, through a moveable cart 250. A prime mover 260, which may be a rotatably driven servo or stepper motor, is rigidly mounted to the frame 212 and drivingly linked to the cart 250, such as by a cogged drive belt 262. The prime mover 260 may be connected to the central computer 300 and may be actuated thereby. The drive belt 262 may be driven by a pulley or cogged wheel attached to the drive shaft of the prime mover 260, and the drive belt 262 may be linked to one end of the cart 250 by a fastener, although equivalent linking mechanisms are contemplated. The rods 230 and 232 thus guide the cart 250 along a horizontal path, which is parallel to the table 215 and parallel to the rods 230 and 232, when driven by the prime mover 260.

The linear actuators 220-224 are rigidly mounted beneath the cart 250 and are connected to the central computer 300 for actuation thereby. Upon actuation, when in an operable orientation, the linear actuators 220-224 drive the blade 216 vertically downwardly and upwardly relative to the table 215 in a manner that drives the blade 216 closer to, and then farther from, the working surface 215′. Thus, the drive system 218 may drive the blade 216 vertically, substantially horizontally (front-to-back), and any combination relative to the table 215. Preferably any vertical movement of the blade 216 only occurs after the rotational and horizontal displacement, but this is not required.

The table drive motor 219 may rotate the table 215 relative to the platform 214 and the blade 216, as controlled by the connected central computer 300. The table drive motor 219 rotates the table 215, and therefore the pizza resting on the table 215, relative to the rotationally stationary blade 116 so that the blade 216 can cut when the pizza is in one location, and then cut the pizza in a rotationally different position without the blade 116 rotating as in the embodiment of FIGS. 1-7. The table drive motor 219 is able to rotate the table 215 in one direction and in the opposite direction at least about 90 degrees, preferably at least 270 degrees, and more preferably 360 degrees or more, all relative to a starting (home) position.

The blade 216 may be disposed above the table 215 by at least about the thickness of the pizza, which will typically be a fraction of an inch to about two inches, with the blade's lower edge 217 substantially parallel to the upper surface 215′ of the table 215. When a pizza is placed on the table 215, the blade 216 is driven downwardly, while maintaining its sharp, downwardly-facing edge 217 parallel to the table, into and through the pizza until the blade contacts the upper surface of the table 215 or comes just above that position, thereby forming a first cut in the pizza. Alternatively, a pizza may be placed on the table 215 on a peel 225, which is a large spatula shown in FIG. 8, and the rams 220, 222 and 224 may be driven a distance that takes into consideration the thickness of the peel 225. In both cases, after cutting of the pizza the blade 216 may then be driven upwardly, moved horizontally front-to-back on the table, and then driven down to make another cut. The table 215 may also or alternatively be rotated after the blade 216 is driven upwardly, thereby positioning the pizza on the table 215 in another rotational position prior to the blade 216 being driven downwardly again. As noted above, it is contemplated that the table 215 may be moved vertically toward the blade (instead of, or in addition to, the blade being moved toward the table) by a linear actuator drivingly linked to the table 215, such as to the table drive motor 219.

After making a first cut as described above, and preferably after the blade is raised above the pizza, the prime movers of the drive system 218, which may be connected to a computer 300 beneath the table 215, may be actuated to drive the cart 250, and therefore the blade 216, horizontally (front to back on the cutter 210) relative to the pizza. Then the rams 220-224 may be driven to move the blade 216 down and up again, to form a second cut in the pizza at a location distal from the first cut. For example, if the first cut is along the diameter of a circular pizza, the second cut may be along a chord of the same pizza after moving the blade horizontally a predetermined amount, such as three to four inches, toward the rear of the cutter 210. Alternatively, the second cut may be made along another diameter of the pizza after rotating the table 215 a predetermined amount from the first cut, such as ten to twenty degrees. If either of these processes is repeated, or if one is carried out and then the other is carried out, these cuts form smaller pizza pieces of the same or varying size. In one embodiment, the first cut may be a chord near one edge of the pizza, and subsequent cuts may be parallel to the first cut but along another chord, one of which may be through the center of the circular pizza. After this first set of parallel cuts is formed, the table 215 may be rotated 90 degrees and additional chord cuts may be made through the pizza perpendicular to the first cuts. Such a pattern of cutting will form mostly rectangular pieces.

The prime movers of the cutter 210 may be powered by electricity, such as when all prime movers are electrical servo motors and linear actuators. The actuation of the prime movers may be controlled by the computer 300 that is connected to the prime movers. A touch screen control unit 310 may be mounted on the front of the cutter, and may be connected to the computer 300. Thus, an operator may press a button on the touch screen thereof that corresponds to the diameter of a circular pizza, thereby programming the computer 300 with information corresponding to the size of the pizza, and the computer 300 then actuates the cutter 210 to carry out one or more of the processes described above.

An alternative blade-cleaning apparatus 400 is shown in FIGS. 13 and 14. The apparatus 400 includes two flexible members 402 and 404 attached to two rigid members 412 and 414, respectively. The rigid members 412 and 414 are mounted in guides 416 and 418 that maintain the orientations of the adjacent edges of the flexible members 402 and 404 relative to one another. The guides 416 and 418 may be rigid structures with slots in which bolts attached to the rigid members 412 and 414 extend. The slots may thereby guide the rigid members toward and away from one another when acted upon by a prime mover 420, which may be a pneumatic ram, hydraulic ram or linear actuator, thereby maintaining the parallel orientation.

The adjacent edges of the flexible members 402 and 404 are preferably parallel, as shown in FIGS. 13 and 14, and the gap between the edges shown in FIG. 13 receives the sharp edge of the blade of an embodiment of the invention, such as the blade 216. The apparatus 400 may be positioned in the void 400′, shown in FIG. 8, between the table 215 and the rear of the frame 212. This positioning allows the blade 216 to be moved, such as after cutting a pizza and before cutting another pizza, by the drive system 218 to the back of the apparatus 210 for cleaning. In a blade cleaning operation, the flexible members 402 and 404 are separated to form a gap as in FIG. 13, and the blade 216 is driven downwardly into the gap. The flexible members 402 and 404 are then driven toward one another by the prime mover 420 that is drivingly linked to the rigid members 412 and 414, thereby seating firmly against the sides of the blade 216 above the food product that may be on the blade 216 due to the previous pizza cutting process. The blade 216 is then raised by the drive system 218 while the edges of the flexible members 402 and 404 are seated firmly against the sides of the blade 216, thereby wiping the sides of the blade of food product in the manner of a squeegee. Once the blade is raised above the flexible members 402 and 404, the flexible members are again separated by the prime mover 420 to form a gap for the next cleaning cycle.

In the blade cleaning process, two long squeegees, which are mounted on electric gripping assemblies or pneumatic gripper rams that the blade is inserted between, clean the length of the blade 216. The grippers close so the squeegees are in contact with the blade, and then the blade is cleaned while being raised through the squeegees. After cleaning, the cleaning assembly opens to release the blade to cut the next pizza. After cutting the next pizza, the blade cleaning process can be carried out again.

In this document, relative movement is sometimes described as a first structure moving relative to a second structure. While this may appear to refer to the first structure moving while the second structure remains stationary, this description is not limited to this scenario. Instead, in the example, the first structure may be stationary while the second structure is moving relative to the first. Still further, this language can also mean both structures are moving, and they are moving relative to one another. Thus, in any part of this document in which one structure is referred to as “moving relative to” another structure, or similar language, the reference should be understood to include the meaning that either one of the structures is moving and the other is stationary, as well as the meaning that both structures are moving and there is relative movement between the two structures.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for cutting food products, the apparatus comprising:
(a) a frame having a table with a working surface;
(b) a blade disposed adjacent the working surface; and
(c) a drive system mounted to the frame, the drive system including:
(i) a prime mover configured for effecting rotational relative motion between the working surface and the blade; and
(ii) a cutting prime mover configured for effecting proximal relative motion between the blade and the working surface.

2. The apparatus in accordance with claim 1, further comprising an aligning prime mover configured for effecting horizontal relative motion between the blade and the working surface.

3. The apparatus in accordance with claim 1, wherein the table is rotatably mounted to the frame and the rotary prime mover is drivingly linked to the table for rotating the table relative to the frame.

4. The apparatus in accordance with claim 1, wherein the blade is rotatably mounted to the frame and the rotary prime mover is drivingly linked to the blade for rotating the blade relative to the table.

5. The apparatus in accordance with claim 1, wherein the cutting linear prime mover is drivingly linked to the blade for displacing the blade vertically relative to the table.

6. The apparatus in accordance with claim 1, wherein the cutting linear prime mover is drivingly linked to the table for displacing the table vertically relative to the blade.

7. The apparatus in accordance with claim 1, wherein the aligning linear prime mover is drivingly linked to the blade for displacing the blade horizontally relative to the table.

8. The apparatus in accordance with claim 1, wherein the aligning linear prime mover is drivingly linked to the table for displacing the table horizontally relative to the blade.

9. The apparatus in accordance with claim 1, further comprising a flexible member mounted across a slot formed in a block, wherein the block is configured to move parallel to the length of the blade.

10. The apparatus in accordance with claim 1, further comprising first and second flexible members drivingly linked to a prime mover, wherein the prime mover moves the flexible members together, when the blade is disposed therebetween, and apart after the blade member has been raised above the flexible members, thereby wiping the blade of residual food product.

11. An apparatus for cutting pizzas, the apparatus comprising:
(a) a frame having a platform;
(b) a table rotatably mounted to the frame adjacent the platform, the table having an upwardly-facing working surface;
(c) a blade disposed above the upwardly-facing working surface; and
(d) a drive system mounted to the frame, the drive system including:
(i) a table prime mover disposed beneath the platform and drivingly linked to the table for rotating the table relative to the blade; and
(ii) a cutting prime mover drivingly linked to the blade for driving the blade vertically relative to the table.

12. The apparatus in accordance with claim 11, further comprising an aligning prime mover drivingly linked to the blade for driving the blade horizontally across the upwardly-facing working surface of the table.

13. The apparatus in accordance with claim 11, further comprising a flexible member mounted across a slot formed in a block, wherein the block is configured to move parallel to the length of the blade.

14. The apparatus in accordance with claim 11, further comprising first and second flexible members drivingly linked to a prime mover, wherein the prime mover moves the flexible members together, when the blade is disposed therebetween, and apart after the blade member has been raised above the flexible members, thereby wiping the blade of residual food product.
